(19) United States
(12) Patent Application Publication
(10) Pub. No.: US 2024/0247002 A1
(43) Pub. Date: Jul. 25, 2024

(54) Flocculation and Rapid Filtration Of Metal Organic Frameworks

(71) Applicant: ExxonMobil Technology and Engineering Company, Annandale, NJ (US)

(72) Inventors: Wesley Sattler, Parsippany, NJ (US); Nicole M. Herb, Allentown, NJ (US); Matthew T. Kapelewski, Lambertville, NJ (US); Aaron W. Peters, New Hope, NJ (US)

(21) Appl. No.: 18/561,626

(22) PCT Filed: May 20, 2022
(86) PCT No.: PCT/US2022/030329

§ 371 Date: Nov. 16, 2023

Related U.S. Application Data
(60) Provisional application No. 63/191,585, filed on May 21, 2021.

(51) Int. Cl. C07F 3/02; C01B 39/00; C07F 11/00; C07F 13/00

(52) U.S. Cl. CPC C07F 3/02; C01B 39/00; C07F 11/00; C07F 13/00; C01P 2002/72

(57) ABSTRACT

Provided herein are methods of making metal-organic frameworks comprising forming a suspension capable of producing metal-organic frameworks; inducing flocculation of the suspension to form a plurality of flocs; allowing the flocs to separate from the suspension and produce a solid phase comprising metal-organic frameworks and a supernatant liquid phase; separating the solid phase from the supernatant liquid phase; and recovering the metal-organic frameworks from the solid phase. The present methods include dissolving a metal salt and at least one ligand in a solvent to form the suspension.

### CROSS REFERENCE TO RELATED APPLICATIONS

The present application claims priority to and the benefit of U.S. Provisional Application No. 63/191,585 filed on May 21, 2021, which is hereby incorporated by reference in its entirety.

### FIELD

The present disclosure generally relates to methods of making metal-organic frameworks, and specifically is directed to flocculation of metal-organic frameworks in synthesis suspensions or slurries to allow for faster and more efficient settling of the metal-organic frameworks and provide for increased space-time yields of the synthesis.

### BACKGROUND

Metal-organic frameworks can be synthesized using mixtures of metal salts, organic ligands, water and organic solvents. As part of the synthesis, the metal-organic frameworks are suspended as a solid phase in a liquid phase or dispersion. The metal-organic frameworks are then isolated and then purified by filtering and washing. Filtration and wash steps can be inefficient and time consuming, lowering the productivity of the synthesis and often resulting in poor properties. The settling time required for these materials and wash steps are often the bottlenecks encountered during the synthesis. Faster and more efficient isolation and purification allows for faster production of the materials and increased space-time yields.

### SUMMARY

Provided herein are methods of making metal-organic frameworks comprising the steps of: forming a suspension capable of producing metal-organic frameworks; producing metal-organic frameworks; inducing flocculation of the suspension to form a plurality of flocs; allowing the flocs to separate from the suspension and produce a solid phase comprising metal-organic frameworks and a supernatant liquid phase; separating the solid phase from the supernatant liquid phase; and recovering the metal-organic frameworks. The methods further comprise the step of dissolving a metal salt and at least one ligand in a non-aqueous solvent to form the suspension.

Also provided herein are methods for accelerating a rate of settling of metal-organic frameworks in a suspension comprising the steps of: providing a suspension of metal-organic frameworks; adding a flocculant to the suspension to form a plurality of flocs comprising aggregates of metal-organic framework particles; and allowing the plurality of flocs to settle out of the suspension to produce metal-organic frameworks having a surface area that is about the same as the surface area of a metal-organic framework produced under the same process conditions but without the flocculant.

Further provided herein are methods for making metal-organic frameworks comprising the steps of: (a) producing metal-organic frameworks in a suspension; (b) adding a flocculant to the suspension to produce a plurality of aggregates of the metal-organic frameworks; (c) settling the plurality of aggregates of metal-organic frameworks out of the suspension to produce a solid phase comprising the metal organic frameworks and a liquid phase; and (d) filtering the solid phase from the liquid phase to provide the metal-organic frameworks. The suspension comprises a plurality of solid reagents in at least one non-aqueous solvent. The solid reagents comprise at least one metal salt and at least one ligand.

These and other features and attributes of the disclosed methods and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings, wherein:

FIG. 1A shows powder x-ray diffraction (“pXRD”) patterns and FIG. 1B provides N₂ isotherms taken at 77 K of Mg-MOF-74 produced with and without flocculation steps as described in Example 1.

FIG. 2A provides the pXRD patterns and FIG. 2B, the N₂ isotherms taken at 77 K of Mg-MOF-74, with and without flocculation as described in Examples 2 and 3.

FIG. 3A provides the pXRD patterns and FIG. 3B, the N₂ isotherms taken at 77 K of UiO-66, with and without flocculation, as described in Example 4.

FIG. 4A provides the pXRD patterns and FIG. 4B, the N₂ isotherms taken at 77 K of HKUST-1, with and without flocculation as described in Example 5.

### DETAILED DESCRIPTION

Before the present methods and devices are disclosed and described, it is to be understood that unless otherwise indicated this invention is not limited to specific compounds, components, compositions, reactants, reaction conditions, ligands, catalyst structures, metallocene structures, or the like, as such may vary, unless otherwise specified. It is also to be understood that the terminology used herein is for the purpose of describing particular embodiments only and is not intended to be limiting.

All numerical values within the detailed description and the claims herein are modified by “about” or “approximately” with respect to the indicated value, and take into account experimental error and variations that would be expected by a person having ordinary skill in the art. Unless otherwise indicated, room temperature is about 25° C.

For the sake of brevity, only certain ranges are explicitly disclosed herein. However, ranges from any lower limit can be combined with any upper limit to recite a range not explicitly recited, as well as, ranges from any lower limit can be combined with any other lower limit to recite a range not explicitly recited, in the same way, ranges from any upper limit can be combined with any other upper limit to recite a range not explicitly recited. Additionally, within a range includes every point or individual value between its end points even though not explicitly recited. Thus, every point or individual value can serve as its own lower or upper limit combined with any other point or individual value or any other lower or upper limit, to recite a range not explicitly recited.

For the purposes of this disclosure, the following definitions will apply:

As used herein, the terms “a” and “the” as used herein are understood to encompass the plural as well as the singular.

The term “aryl” means, unless otherwise stated, a polyunsaturated, aromatic substituent that can be a single ring or multiple rings fused together or linked covalently. In an aspect, the substituent has from 1 to 11 rings, or more specifically, 1 to 3 rings. The term “heteroaryl” refers to aryl substituent groups (or rings) that contain from one to four heteroatoms selected from N, O and S, wherein the nitrogen and sulfur atoms are optionally oxidized, and the nitrogen atom(s) are optionally quaternized. An exemplary heteroaryl group is a six-membered azine, e.g., pyridinyl, diazinyl and triazinyl. A heteroaryl group can be attached to the remainder of the molecule through a heteroatom. Non-limiting examples of aryl and heteroaryl groups include phenyl, 1-naphthyl, 2-naphthyl, 4-biphenyl, 1-pyrrolyl, 2-pyrrolyl, 3-pyrrolyl, 3-pyrazolyl, 2-imidazolyl, 4-imidazolyl, pyrazinyl, 2-oxazolyl, 4-oxazolyl, 2-phenyl-4-oxazolyl, 5-oxazolyl, 3-isoxazolyl, 4-isoxazolyl, 5-isoxazolyl, 2-thiazolyl, 4-thiazolyl, 5-thiazolyl, 2-furyl, 3-furyl, 2-thienyl, 3-thienyl, 2-pyridyl, 3-pyridyl, 4-pyridyl, 2-pyrimidyl, 4-pyrimidyl, 5-benzothiazolyl, purinyl, 2-benzimidazolyl, 5-indolyl, 1-isoquinolyl, 5-isoquinolyl, 2-quinoxalinyl, 5-quinoxalinyl, 3-quinolyl, and 6-quinolyl. Substituents for each of the above noted aryl and heteroaryl ring systems are selected from the group of acceptable substituents described below.

As used herein, the terms “alkyl,” “aryl,” and “heteroaryl” can optionally include both substituted and unsubstituted forms of the indicated species. Substituents for the aryl and heteroaryl groups are generically referred to as “aryl group substituents.” The substituents are selected from, for example: groups attached to the heteroaryl or heteroarene nucleus through carbon or a heteroatom (e.g., P, N, O, S, Si, or B) including, without limitation, substituted or unsubstituted alkyl, substituted or unsubstituted aryl, substituted or unsubstituted heteroaryl, substituted or unsubstituted heterocycloalkyl, —OR′, ═O, ═NR′, ═N—OR′, —NR′R″, —SR′, -halogen, —SiR′R″R′″, —OC(O)R′, —C(O)R′, —CO₂R′, —CONR′R″, —OC(O)NR′R″, —NR″C(O)R′, —NR′—C(O)NR″R′″, —NR″C(O)₂R′, —NR—C(NR′R″R′″)═NR″″, —NR—C(NR′R″)═NR′″, —S(O)R′, —S(O)R′, —S(O)NR′R″, —NRSOR′, —CN and, —R′, —, —CH(Ph), fluoro(C₁-C₄)alkoxy, and fluoro(C₁-C₄)alkyl, in a number ranging from zero to the total number of open valences on the aromatic ring system. Each of the above-named groups is attached to the aryl or heteroaryl nucleus directly or through a heteroatom (e.g., P, N, O, S, Si, or B); and where R′, R″, R′″ and R″″ can be independently selected from hydrogen, substituted or unsubstituted alkyl, substituted or unsubstituted heteroalkyl, substituted or unsubstituted aryl and substituted or unsubstituted heteroaryl. When a compound includes more than one R group, for example, each of the R groups is independently selected as are each R′, R″, R′″ and R″″ groups when more than one of these groups is present.

The term “alkyl,” by itself or as part of another substituent, means, unless otherwise stated, a straight or branched chain, or cyclic hydrocarbon radical, or combination thereof, which can be fully saturated, mono- or polyunsaturated and can include di-, tri- and multivalent radicals, having the number of carbon atoms designated (i.e., C₁-C₁₀ means one to ten carbons). Examples of saturated hydrocarbon radicals include, but are not limited to, groups such as methyl, ethyl, n-propyl, isopropyl, n-butyl, t-butyl, isobutyl, sec-butyl, cyclohexyl, (cyclohexyl)methyl, cyclopropylmethyl, homologs and isomers of, for example, n-pentyl, n-hexyl, n-heptyl, n-octyl, and the like. An unsaturated alkyl group is one having one or more double bonds or triple bonds. Examples of unsaturated alkyl groups include, but are not limited to, vinyl, 2-propenyl, crotyl, 2-isopentenyl, 2-(butadienyl), 2,4-pentadienyl, 3-(1,4-pentadienyl), ethynyl, 1- and 3-propynyl, 3-butynyl, and the higher homologs and isomers. The term “alkyl,” unless otherwise noted, is also meant to optionally include those derivatives of alkyl defined in more detail below, such as “heteroalkyl.”

The terms “halo” or “halogen,” by themselves or as part of another substituent, mean, unless otherwise stated, a fluorine, chlorine, bromine, or iodine atom.

As used herein, an “isotherm” refers to the adsorption of an adsorbate as function of concentration while the temperature of the system is held constant. In an embodiment, the adsorbate is CO₂ and concentration can be measured as CO₂ pressure. As described herein, isotherms can be performed with porous materials and using various mathematical models applied to calculate the apparent surface area. Brunauer, S. et al., Adsorption Gas in Multimolecular Layers, J. Am. Chem. Soc., 60, 309-319, 1938; Walton, K. et al., Applicability of BET Method for Determining Surface Areas of Microporous Metal-Organic Frameworks, J. Am. Chem. Soc. 129, 8552-8556, 2007; Langmuir, I., J. The Constitution of Fundamental Properties of Solids and Liquids, Part 1. Solids, Am. Chem. Soc., 38, 2221-2295, 1916.

As used herein, the term “ligand” means a molecule containing one or more substituent groups capable of functioning as a Lewis base (electron donor). In an aspect, the ligand can be oxygen, phosphorus or sulfur-containing molecules. In an aspect, the ligand can be an amine or amines containing 1 to 10 amine groups.

The symbol “R” is a general abbreviation that represents a substituent group that is selected from H, substituted or unsubstituted alkyl, substituted or unsubstituted heteroalkyl, substituted or unsubstituted aryl, substituted or unsubstituted heteroaryl, and substituted or unsubstituted heterocycloalkyl groups.

As used herein, the term “Periodic Table” means the Periodic Table of the Elements of the International Union of Pure and Applied Chemistry (IUPAC), dated December 2015.

The term “salt(s)” includes salts of the compounds prepared by the neutralization of acids or bases, depending on the particular ligands or substituents found on the compounds described herein. When compounds contain relatively acidic functionalities, base addition salts can be obtained by contacting the neutral form of such compounds with a sufficient amount of the desired base, either neat or in a suitable inert solvent. Examples of base addition salts include sodium, potassium, calcium, ammonium, organic amino, or magnesium salt, or a similar salt. Examples of acid addition salts include those derived from inorganic acids like hydrochloric, hydrobromic, nitric, carbonic, monohydrogencarbonic, phosphoric, monohydrogenphosphoric, dihydrogenphosphoric, sulfuric, monohydrogensulfuric, hydriodic, or phosphorous acids, and the like, as well as the salts derived from relatively nontoxic organic acids like acetic, propionic, isobutyric, butyric, maleic, malic, malonic, benzoic, succinic, suberic, fumaric, lactic, mandelic, phthalic, benzenesulfonic, p-tolylsulfonic, citric, tartaric, methanesulfonic, and the like. Certain specific compounds of the present disclosure contain both basic and acidic functionalities that allow the compounds to be converted into either base or acid addition salts. Hydrates of the salts are also included.

It is understood that, in any compound described herein having one or more chiral centers, if an absolute stereochemistry is not expressly indicated, then each center may independently be of R-configuration or S-configuration or a mixture thereof. Thus, the compounds provided herein can be enantiomerically pure or be stereoisomeric mixtures. In addition, it is understood that, in any compound described herein having one or more double bond(s) generating geometrical isomers that can be defined as E or Z, each double bond may independently be E or Z or a mixture thereof. Likewise, it is understood that, in any compound described, all tautomeric forms are also intended to be included.

In addition, the compounds provided herein may also contain unnatural proportions of atomic isotopes at one or more of the atoms that constitute such compounds. For example, the compounds can be radiolabeled with radioactive isotopes, such as for example tritium (³H), iodine-125 (¹²⁵I) or carbon-14 (¹⁴C). All isotopic variations of the subject compounds, whether radioactive or not, are intended to be encompassed within the scope of present disclosure.

As used herein, the terms, “metal organic-framework material” or “MOF material” refer to a metal or metalloid and an organic ligand capable of coordination with the metal or metalloid. In certain embodiments, MOF coordination networks of organic ligands and metals (or metalloids) form porous three-dimensional structures.

As used herein, a “metal organic framework” can be a mixed-metal organic framework or a metal-organic framework system or a mixed-metal mixed-organic framework system as described in PCT published application, WO/2020/219907.

### Metal-Organic Frameworks

Metal-organic frameworks (“MOFs”) are a class of highly porous materials with potential applications in a wide range of fields including gas storage, gas and liquid separations, isomer separation, waste removal, and catalysis, among others. In contrast to zeolites, which are purely inorganic in character, MOFs utilize organic ligands which can function as “struts” bridging metal atoms or clusters of metal atoms together. Like zeolites, MOFs are microporous. The pore shape and size of the metal-organic framework (“MOF”) can be tuned through selection of the organic ligands and metals. Because organic ligands can be modified, MOFs as a whole are structurally diverse which is different than zeolites. Factors that influence the structure of MOFs include, for example, one or more of ligand denticity, size and type of the coordinating group(s), additional substitution remote or proximate to the coordinating groups, ligand size and geometry, ligand hydrophobicity or hydrophilicity, choice of metal and/or metal salt, choice of solvent, and reaction conditions such as temperature, concentration, and the like.

Metal Organic Frameworks (MOFs) are materials made of metals and multi-topic organic linkers that self-assemble to form a coordination network. MOFs have wide-ranging potential uses in many different applications including gas storage, gas separation, catalysis, sensing, and environmental remediation.

As provided herein, the metal-organic framework can be ZIFs (or Zeolitic Imidazolate Frameworks), MILs (or Máteriaux de l'Institut Lavoisier), IRMOFs (or IsoReticular Metal Organic Frameworks), alone or in combination with other MOFs. In certain embodiments, the MOF is selected from: HKUST-1, MOF-74, MIL-100, ZIF-7, ZIF-8, ZIF-90, UiO-66, UiO-67, MOF-808 or MOF-274. In an aspect, the metal-organic framework is selected from the group of HKUST-1, UiO-66, ZIF-8, ZIF-7, MIL-100, MOF-74, M₂(m-dobdc), MOF-274, Cu(Qc)₂ and combination(s) thereof.

MOFs can be prepared via combination of an organic ligand, or one or a combination of two or more organic ligands, and a metal or metalloid as described below. For example, MOF-274 and EMM-67 are a combination of Mg²⁺, Mn²⁺, Fe²⁺, Zn²⁺, Ni²⁺, Cu²⁺, Co²⁺ or combinations thereof with 4,4′-dihydroxy-(1,1′-biphenyl)-3,3′-dicarboxylic acid. Additionally, MOF-274 can include amines coordinated to the metal sites within its structure.

### Organic Ligands

As used herein, an organic ligand is a ligand that is monodentate, bidentate, or multi-dentate. The organic ligand can be a single type of ligand, or combination(s) thereof. Generally, the organic ligand is capable of coordination with the metal ion, in principle all compounds can be used which are suitable for such coordination. Organic ligands including at least two centers, which are capable to coordinate the metal ions of a metal salt, or metals or metalloids. In an aspect, an organic ligand includes: i) an alkyl group substructure, having from 1 to 10 carbon atoms, ii) an aryl group substructure, having from 1 to 5 aromatic rings, iii) an alkyl or aryl amine substructure, consisting of alkyl groups having from 1 to 10 carbon atoms or aryl groups having from 1 to 5 aromatic rings, where the substructures have at least two functional groups “X”, which are covalently bound to the substructure, and where X is capable of coordinating to a metal or metalloid.

In an aspect, each X is independently selected from neutral or ionic forms of CO₂H, OH, SH, NH₂, CN, HCO, CS₂H, NO₂, SO₃H, Si(OH)₃, Ge(OH)₃, Sn(OH)₃, Sn(SH)₃, PO₃H, CH(RSH)₂, C(RSH)₃, CH(RNH₂)₂, C(RNH₂)₃, CH(ROH)₂, C(ROH)₃, CH(RCN)₂, C(RCN)₃, CH(SH)₂, C(SH)₃, CH(NH₂)₂, C(NH₂)₂, CH(OH)₂, C(OH)₃, CH(CN)₂, C(CN)₃, nitrogen-containing heterocycles, sulfur-containing heterocycles, and combination(s) thereof, where R is an alkyl group having from 1 to 5 carbon atoms, or an aryl group consisting of 1 to 2 phenyl rings.

In an aspect, the organic ligand includes substituted or unsubstituted, mono- or polynuclear aromatic di-, tri- and tetracarboxylic acids and substituted or unsubstituted, at least one hetero atom including aromatic di-, tri- and tetracarboxylic acids, which have one or more nuclei.

In an aspect, the organic ligand is benzenetricarboxylate (BTC) (one or more isomers), ADC (acetylene dicarboxylate), NDC (naphtalenedicarboxylate) (any isomer), BDC (benzene dicarboxylate) (any isomer), ATC (adamantanetetracarboxylate) (any isomer), BTB (benzenetribenzoate) (any isomer), MTB (methane tetrabenzoate), ATB (adamantanetribenzoate) (any isomer), biphenyl-4,4′-dicarboxylate, benzene-1,3,5-tris(1H-tetrazole), imidazole, or derivatives thereof, or combination(s) thereof.

Ligands which possess multidentate functional groups can include corresponding counter cations, such as H⁺, Na⁺, K⁺, Mg²⁺, Ca²⁺, Sr²⁺, ammonium ion, alkylsubstituted ammonium ions, and arylsubstituted ammonium ions, or counteranions, such as F⁻, Cl⁻, Br⁻, I⁻, ClO⁻, ClO₂⁻, ClO₃⁻, ClO₄⁻, OH⁻, NO₃⁻, NO₂⁻, SO₄²⁻, SO₃²⁻, PO₄³⁻, CO₃²⁻, and HCO³⁻.

In an aspect, the organic ligands include monodentate functional groups. A monodentate functional group is defined as a moiety bound to a substructure, which can include an organic ligand or amine ligand substructure, L, as defined previously, which can form only one bond to a metal ion. According to this definition, a ligand can contain one or more monodentate functional groups. For example, cyclohexylamine and 4,4′-bipyridine are ligands that contain monodentate functional groups, since each functional group is capable of binding to only one metal ion.

Accordingly, cyclohexylamine is a monofunctional ligand containing a monodentate functional group and 4,4′-bipyridine is a bifunctional ligand containing two monodentate functional groups. Specific examples of ligands containing monodentate functional groups are pyridine, which is a monofunctional ligand, hydroquinone, which is a difunctional ligand, and 1,3,5-tricyanobenzene, which is a trifunctional ligand.

Ligands having monodentate functional groups can be blended with ligands that contain multidentate functional groups to make an MOF in the presence of a suitable metal ion and optionally a templating agent. Monodentate ligands can also be used as templating agents. Templating agents can be added to the reaction mixture for the purpose of occupying the pores in the resulting MOF. Monodentate ligands and/or templating agents can include the following substances and/or derivatives thereof.
A. Alkyl or aryl amines or phosphines and their corresponding ammonium or phosphonium salts, the alkyl amines or phosphines can include linear, branched, or cyclic aliphatic groups, having from 1 to 20 carbon atoms (and their corresponding ammonium salts), the aryl amines or phosphines can include 1 to 5 aromatic rings including heterocycles. Examples of monofunctional amines are methylamine, ethylamine, n-propylamine, iso-propylamine, n-butylamine, sec-butylamine, iso-butylamine, tert-butylamine, n-pentylamine, neo-pentylamine, n-hexylamine, pyrrolidine, 3-pyrroline, piperidine, cyclohexylamine, morpholine, pyridine, pyrrole, aniline, quinoline, isoquinoline, 1-azaphenanthrene, and 8-azaphenanthrene. Examples of difunctional and trifunctional amines are 1,4-diaminocyclohexane, 1,4-diaminobenzene, 4,4′-bipyridyl, imidazole, pyrazine, 1,3,5-triaminocyclohexane, 1,3,5-triazine, and 1,3,5-triaminobenzene.
B. Alcohols that contain alkyl or cycloalkyl groups, containing from 1 to 20 carbon atoms, or aryl groups, containing from 1 to 5 phenyl rings. Examples of monofunctional alcohols are methanol, ethanol, n-propanol, iso-propanol, allyl alcohol, n-butanol, iso-butanol, sec-butanol, tert-butanol, n-pentanol, iso-pentanol, sec-pentanol, neo-pentanol, n-hexanol, cyclohexanol, phenol, benzyl alcohol, and 2-phenylethanol. Examples of difunctional and trifunctional alcohols are 1,4-dihydroxycyclohexane, hydroquinone, catechol, resorcinol, 1,3,5-trihydroxybenzene, and 1,3,5-trihydroxycyclohexane.
C. Ethers that contain alkyl or cycloalkyl groups, containing from 1 to 20 carbon atoms, or aryl groups, containing from 1 to 5 phenyl rings. Examples of ethers are diethyl ether, furan, and morpholine.
D. Thiols that contain alkyl or cycloalkyl groups, containing from 1 to 20 carbon atoms, or aryl groups, containing from 1 to 5 phenyl rings. Examples of monofunctional thiols are thiomethane, thioethane, thiopropane, thiocyclohexane, thiophene, benzothiophene, and thiobenzene. Examples of difunctional and trifunctional thiols are 1,4-dithiocyclohexane, 1,4-dithiobertzene, 1,3,5-trithiocyclohexane, and 1,3,5-trithiobenzene.
E. Nitriles that contain alkyl or cycloalkyl groups, containing from 1 to 20 carbon atoms, or aryl groups, containing from 1 to 5 phenyl rings. Examples of monofunctional nitriles are acetonitrile, propanenitrile, butanenitrile, n-valeronitrile, benzonitrile, and p-tolunitrile. Examples of difunctional and trifunctional nitriles are 1,4-dinitrilocyclohexane, 1,4-dinitrilobenzene, 1,3,5-trinitrilocyclohexane, and 1,3,5-trinitrilobenzene.
F. Inorganic anions from the group consisting of: sulfate, nitrate, nitrite, sulfite, bisulfite, phosphate, hydrogen phosphate, dihydrogen phosphate, diphosphate, triphosphate, phosphite, chloride, chlorate, bromide, bromate, iodide, iodate, carbonate, bicarbonate, thiocyanide and isonitrile, and the corresponding acids and salts of the aforementioned inorganic anions.
G. Organic acids and the corresponding anions (and salts). The organic acids can include alkyl organic acids containing linear, branched, or cyclic aliphatic groups, having from 1 to 20 carbon atoms, or aryl organic acids and their corresponding aryl organic anions and salts, having from 1 to 5 aromatic rings which can include heterocycles.
H. Other organic and inorganics such as ammonia, carbon dioxide, methane, oxygen, ethylene, hexane, benzene, toluene, xylene, chlorobenzene, nitrobenzene, naphthalene, thiophene, pyridine, acetone, 1-2-dichloroethane, methylenechloride, tetrahydrofuran, ethanolamine, triethylamine or trifluoromethylsulfonic acid.

Additionally, templating agents can include other aliphatic and aromatic hydrocarbons not containing functional groups. In an aspect, templating agents include cycloalkanes, such as cyclohexane, adamantane, or norbomene, and/or aromatics, such as benzene, toluene, or xylenes.

### The Metal Ions

As described above, the MOF can be synthesized by combining metal ions, organic ligands, and optionally a suitable templating agent. Suitable metal ions include metals and metalloids of varying coordination geometries and oxidation states. In an aspect, MOFs are produced using metal ions having distinctly different coordination geometries, in combination with a ligand possessing multidentate functional groups, and a suitable templating agent. MOFs can be prepared using a metal ion that prefers octahedral coordination, such as cobalt (II), and/or a metal ion that prefers tetrahedral coordination, such as zinc (II). MOFs can be made using one or more of the following metal ions: Mg²⁺, Ca²⁺, Sr²⁺, Ba²⁺, Sc³⁺, Y³⁺, Ti⁴⁺, Zr⁴⁺, Hf⁴⁺, V⁵⁺, V⁴⁺, V³⁺, V²⁺, Nb³⁺, Ta³⁺, Cr³⁺, Mo³⁺, W³⁺, Mn³⁺, Mn²⁺, Re³⁺, Re²⁺, Fe³⁺, Fe²⁺, Ru³⁺, Ru²⁺, Os³⁺, Os²⁺, Co³⁺, Co²⁺, Rh²⁺, Rh⁺, Ir²⁺, Ir⁺, Ni²⁺, Ni⁺, Pd²⁺, Pt²⁺, Pt⁺, Cu²⁺, Cu⁺, Ag⁺, Au⁺, Zn²⁺, Cd²⁺, Hg²⁺, Al³⁺, Ga³⁺, In³⁺, Tl³⁺, Si⁴⁺, Si²⁺, Ge⁴⁺, Ge²⁺, Sn⁴⁺, Sn²⁺, Pb⁴⁺, Pb²⁺, As⁵⁺, As³⁺, As⁺, Sb⁵⁺, Sb³⁺, Sb⁺, and Bi⁵⁺, Bi³⁺, Bi⁺, Be²⁺; along with the corresponding metal salt counterion. The term metal ion refers to both metal and metalloid ions. In an aspect, metal ions suitable for use in production of MOFs can include: Sc³⁺, Ti⁴⁴⁺, V³⁺, V²⁺, Cr³⁺, Mo³⁺, Mg²⁺, Mn³⁺, Mn²⁺, Fe³⁺, Fe²⁺, Ru³⁺, Ru²⁺, Os³⁺, Os²⁺, Co³⁺, Co²⁺, Rh²⁺, Rh⁺, Ir²⁺, Ir⁺, Ni²⁺, Ni⁺, Pd²⁺, Pd⁺, Pt²⁺, Pt⁺, Cu²⁺, Cu⁺, Ag⁺, Au⁺, Zn²⁺, Cd²⁺, Al³⁺, Ga³⁺, In³⁺, Ge⁴⁺, Ge²⁺, Sn⁴⁺, Sn²⁺, Pb⁴⁺, Pb²⁺, Sb⁵⁺, Sb³⁺, Sb⁺, and/or Bi⁵⁺, Bi³⁺, Bi⁺, Be²⁺; along with the corresponding metal salt counteranion. In an aspect, metal ions for use in production of MOFs include: Sc³⁺, Ti⁴⁺, V⁴⁺, V³⁺, Cr³⁺, Mo³⁺, Mn³⁺, Mn²⁺, Fe³⁺, Fe²⁺, Co³⁺, Co²⁺, Ni²⁺, Ni⁺, Cu²⁺, Cu⁺, Ag⁺, Zn²⁺, Cd²⁺, Al³⁺, Sn⁴⁺, Sn²⁺ and/or Bi⁵⁺, Bi³⁺, Bi⁺; along with the corresponding metal salt counterion. In an aspect, the metal ions for use in production of MOFs are selected from the group consisting of: Mg²⁺, Mn³⁺, Mn²⁺, Fe³⁺, Fe²⁺, Co³⁺, Co²⁺, Ni²⁺, Ni⁺, Cu²⁺, Cu⁺, Pt²⁺, Ag⁺, and Zn²⁺, along with the corresponding metal salt counterion.

### Preparation of Metal-Organic Frameworks

The synthesis of a rigid and stable metal-organic framework (“MOF”) can be carried out under mild reaction conditions where reagents are combined into a solution with synthetic reaction temperatures ranging from 0° C. to 100° C. (in an open beaker). In other cases, solution reactions are carried out in a closed vessel at temperatures from 25° C. to 300° C. In either case, crystalline microporous solids or powder is formed.

In the preparation of the metal-organic frameworks, reactants are added in a mole ratio of 1:10 to 10:1 metal ion to ligand containing multidentate functional groups. In an aspect, the ratio of the metal ion to ligand containing multidentate functional groups is 1:3 to 3:1, such as from 1:2 to 2:1. The amount of templating agent can affect production, and in fact, templating agent can in certain circumstances be employed as the solvent in which the reaction takes place. Templating agents can accordingly be employed in excess without interfering with the reactions or the overall synthesis. Additionally, when using a ligand containing monodentate functional groups in combination with the metal ion and the ligand containing multidentate functional groups, the ligand containing monodentate functional groups can be utilized in excess. In certain circumstances the ligand containing monodentate functional groups can be utilized as the solvent in which the reaction takes place. In addition, in certain circumstances the templating agent and the ligand containing monodentate functional groups can be identical. An example of a templating agent which is a ligand containing monodentate functional groups is pyridine.

To make the metal-organic framework, the reaction is carried out in a non-aqueous system. The solvent can be polar or nonpolar, and the solvent can be a templating agent, or the optional ligand containing a monodentate functional group. Examples of non-aqueous solvents include n-alkanes, such as pentane, hexane, benzene, toluene, xylene, chlorobenzene, nitrobenzene, cyanobenzene, aniline, naphthalene, naphthas, n-alcohols such as methanol, ethanol, n-propanol, isopropanol, acetone, 1,2,-dichloroethane, methylene chloride, chloroform, carbon tetrachloride, tetrahydrofuran, dimethylformamide, dimethylformamide, dimethylsulfoxide, thiophene, pyridine, ethanolamine, triethylamine, ethylenediamine, and the like.

To form large single crystals of microporous materials, suitable for single crystal x-ray structural characterization, the solution reaction can be performed in the presence of viscous materials, such as polymeric additives. Specific additives can include polyethylene oxide, polymethylmethacrylic acid, silica gels, agar, fats, and collagens, which can aid in achieving high yields and pure crystalline products. The growth of large single crystals of microporous materials leads to unambiguous characterization of the microporous framework. Large single crystals of microporous materials can be useful for magnetic and electronic sensing applications.

### Optional Additives

Additionally, the metal-organic framework coating layer can comprise additives such as fillers, antioxidants (e.g., hindered phenolics such as IRGANOX™ 1010 or IRGANOX™ 1076 available from Ciba-Geigy), inhibitors of photo-oxidation (e.g., hindered amine light stabilizers, HALS, such as TINUVN® 123 available from BASF, phosphites (e.g., IRGAFOS™ 168 available from Ciba-Geigy), anti-cling additives, tackifiers, such as polybutenes, terpene resins, aliphatic and aromatic hydrocarbon resins, alkali metal and glycerol stearates, and hydrogenated rosins, UV stabilizers; heat stabilizers, anti-blocking agents, release agents, anti-static agents, pigments; colorants, dyes, waxes, silica, fillers, and talc.

Other optional additives include silica, such as precipitated silica and silica originating from by-products such as fly-ash, for example silica-alumina, silica-calcium particles, or fumed silica. In an aspect, the silica is particulate matter and has an average particle size of 10 μm or less, such as 5 μm or less, or 1 μm or less. In an aspect, the silica is amorphous silica.

Other additives that can be optionally included in the metal-organic coating layer include inorganic compounds, such as titanium dioxide, hydrated titanium dioxide, hydrated alumina or alumina derivatives, mixtures of silicon and aluminum compounds, silicon compounds, clay minerals, alkoxysilanes, and amphiphilic substances. Additives can also include any suitable compound use for adhesion of powdery materials, such as oxides, of silicon, of aluminum, of boron, of phosphorus, of zirconium and/or of titanium. Additionally, additives can include oxides of magnesium and of beryllium. Furthermore, tetraalkoxysilanes can be used as additives, such as tetramethoxysilane, tetraethoxysilane, tetrapropoxysilane and tetrabutoxysilane, the analogous tetraalkoxytitanium and tetraalkoxyzirconium compounds and trimethoxy-, triethoxy-, tripropoxy- and tributoxy-aluminum.

### Present Methods

Metal-organic frameworks are prepared by reactions of pre-synthesized or commercially available ligands with metal ions. An alternative approach, referred to as “in situ linker synthesis,” specified organic ligands also referred to sometimes as “linkers” can be generated in the reaction media in situ from the starting materials.

In synthesizing the metal-organic framework, organic molecules are not only structure-directing agents but as reactants to be incorporated as part of the framework structure. With this in mind, elevated reaction temperatures can be employed in conventional synthesis. Solvothermal reaction conditions, structure-directing agents, mineralizers as well as microwave-assisted synthesis or steam-assisted conversions have also been recently introduced.

A traditional synthesis can be carried out by conventional electric heating without any parallel reactions. In the traditional synthesis, reaction temperature is often a parameter of a synthesis of the metal-organic framework and two temperature ranges, solvothermal and nonsolvothermal, are distinguished, which dictate the reaction setups utilized. Solvothermal reactions often take place in closed vessels under autogenous pressure about the boiling point of the solvent used. Nonsolvothermal reactions take place below, or at the boiling point under ambient pressure, simplifying synthetic requirements. Nonsolvothermal reactions can be further classified as room-temperature or elevated temperatures.

Synthesis of metal-organic frameworks often takes place in a solvent and at temperatures ranging from room temperature to approximately 250° C. Heat is transferred from a hot source, the oven, through convection. Alternatively, energy can be introduced through an electric potential, electromagnetic radiation, mechanical waves (ultrasound), or mechanically. The energy source is closely related to the duration, pressure, and energy per molecule that is introduced into a system, and each of these parameters can have a strong influence on the metal-organic framework formed and its morphology.

Traditional synthesis of metal-organic frameworks is described in McDonald, T., Mason, J., Kong, X. et al, Cooperative insertion of CO₂ in diamine-appended metal-organic frameworks, Nature 519, 303-08 (2015), which is incorporated herein by reference. Generally, 0.10 mmol of a linker, 0.25 mmol of metal salts, and 10 mL of a solvent, i.e., methanol/dimethylformamide (DMF) are combined together in a 20 mL glass scintillation vial. The vial is then sealed and placed in a well plate two (2) cm deep on a 393° K hot plate for about 12 hours, after which a powder forms on the bottom and walls of the vial. The metal-organic framework material is then decanted and the remaining powder soaked three times in DMF and then three times in methanol. The metal-organic frameworks are then collected by filtration and fully desolvated by heating under dynamic vacuum (<10 μbar) at 523° K for 24 hours. Using this specific methodology, yields about 0.073 mmol of metal-organic frameworks, or 73% yield (comparing mmol of the metal-organic frameworks produced to initial mmol of linker) or a volume-normalized mass-based yield of 2.7 grams MOF per liter of reaction solution.

In addition to the traditional synthesis described by McDonald, T. et al., Cooperative Insertion of CO₂ in Diamine-Appended Metal-Organic Frameworks, Nature, 519, 303-308, 2015, incorporated herein by reference, other suitable synthesis of making metal-organic frameworks are described by McDonald, T. et al., Capture of Carbon Dioxide from Air and Flue Gas in the Alkylamine Appended Metal-Organic Framework mmen-Mg2 (dobpdc), J. Am. Chem. Soc. 134, 7056-7065, 2012, Xiao, D. et al., Pore Environmental Effectors on Catalytic Cyclohexance Oxidation in Expanded Fe₂(dobdc) Analogues, J. Am. Chem. Sci, 9, 160-174; 2018; U.S. Pat. No. 8,653,292; and US Pub. Patent App Nos. 2007/0202038, 2010/0307336, and 2016/0031920.

As provided herein, metal-organic frameworks are synthesized using suspensions of metal salts and organic ligands and at least one solvent. The metal-organic frameworks are suspended as a solid phase in a liquid phase or dispersion, which is isolated and purified by filtration and washing steps. Depending on particle size and other colloidal properties of the metal-organic framework, filtration and washing steps can be time-consuming and inefficient, lowering the productivity of the synthesis and resulting in poor properties of the metal-organic framework produced. In fact, settling times required for these porous materials is often the bottleneck in many syntheses, second only to the washing step.

Flocculation is a process in which colloids or dispersions come out of suspension in the form of a floc or flake. There are different mechanisms of flocculation, all of which generally increase a material's particle size. Here we demonstrate for the first time that polymers may be added to a MOF suspension to form flocs (larger aggregates of MOFs) which results in rapid settling (within minutes) and easier filtration of reaction or washing mixtures.

Flocculation is the aggregation of particles of a colloidal suspension to form larger particles caused by random collisions between the suspended particles. In time, large enough particles are formed such that they will separate out due density differences (creaming vs. sedimentation). Colloidal suspensions often have a long life due to repulsion between like charges, which keeps the particles from aggregating. Flocculation can be induced by the addition of a flocculating agent, for example, an electrolyte that essentially neutralizes the charged particles so that, subsequently, aggregation may occur. Polymers provide significant Van der Waals interactions due to their size.

Provided herein are methods of making metal-organic frameworks comprising the steps: (a) forming a suspension capable of producing metal-organic frameworks; (b) inducing flocculation of the suspension to form a plurality of flocs; (c) allowing the flocs to separate from the suspension and produce a solid phase comprising metal-organic frameworks and a supernatant liquid phase; (d) separating the solid phase from the supernatant liquid phase; and (e) recovering the metal-organic frameworks from the solid phase. In an aspect, the methods further comprise the step of dissolving a metal salt and at least one ligand in a solvent to form the suspension.

In the present methods, flocculation is induced by the addition of a polymer solution. In an aspect, the polymer solution comprises p(amic acid). In an aspect, the suspension is stirred when inducing flocculation. In an aspect, the polymer is added to the suspension in an amount between about 0.1 wt. % to 15 wt. % based on the solid phase, or between 1 wt. % and 5 wt. % based on the solid phase. The flocs are aggregates of metal-organic framework particles. The flocs separate from the suspension and settle out of the suspension. In an aspect, the solid phase is then separated from the liquid phase by filtering the solid phase from the liquid phase. The metal-organic frameworks can be recovered as the solid phase by washing the metal-organic framework material with one or more solvents. In an aspect, the metal-organic framework is recovered by washing the solid phase with DMF and methanol.

Also provided herein are methods for accelerating a rate of settling of metal-organic frameworks in a suspension comprising: providing a suspension of metal-organic frameworks; adding a flocculant to the suspension to form a plurality of flocs comprising aggregates of metal-organic framework particles, and allowing the plurality of flocs to settle out of the suspension to produce metal-organic frameworks having a surface area that is about the same as the surface area of a metal-organic framework produced under the same process conditions but without the flocculant.

Further, provided herein are methods for making metal-organic frameworks comprising the steps of: (a) producing metal-organic frameworks in a suspension; (b) adding a flocculant to the suspension to produce a plurality of aggregates of the metal-organic frameworks; (c) settling the plurality of aggregates of metal-organic frameworks out of the suspension to produce a solid phase comprising the metal organic frameworks and a liquid phase; and (d) filtering the solid phase from the liquid phase to provide the metal-organic frameworks. The suspension comprises a plurality of solid reagents and at least one solvent. The solid reagents comprise at least one metal salt and at least one ligand. In an aspect, the solid phase is washed with DMF and methanol. In an aspect, the solid phase is washed with water or methanol or ethanol or a combination thereof.

In an aspect, the present methods make a metal-organic framework comprising an organic ligand comprising one or more of: an alkyl group substructure having from 1 to 10 carbon atoms; or an aryl group substructure having from 1 to 5 aromatic rings. The one or more substructures each have at least two X groups, and wherein X is a functional group configured to coordinate to a metal or metalloid. In an aspect, the present methods can make a metal-organic framework comprises an organic ligand comprising an alkylamine substructure having from 1 to 10 carbon atoms or an arylamine or nitrogen-containing heterocycle substructure having from 1 to 5 aromatic rings; and wherein the substructure(s) each have at least two X groups, and wherein X is a functional group configured to coordinate to a metal or metalloid. In an aspect, in either instance, each X is independently selected from neutral or ionic forms of CO₂H, OH, SH, OH₂, NH₂, CN, HCO, CS₂H, NO₂, SO₃H, Si(OH)₃, Ge(OH)₃, Sn(OH)₃, Si(SH)₄, Ge(SH)₄, Sn(SH)₃, PO₃H, AsO₃H, AsO₄H, P(SH)₃, As(SH)₃, CH(RSH)₂, C(RSH)₃, CH(RNH₂)₂, C(RNH₂)₃, CH(ROH)₂, C(ROH)₃, CH(RCN)₂, C(RCN)₃, CH(SH)₂, C(SH)₃, CH(NH₂)₂, C(NH₂)₂, CH(OH)₂, C(OH)₃, CH(CN)₂, C(CN)₃, nitrogen-containing heterocycles, sulfur-containing heterocycles, or combination(s) thereof, wherein R is an alkyl group having from 1 to 5 carbon atoms or an aryl group of 1 to 2 phenyl rings. In an aspect, the organic ligand is 1,3,5-benzenetricarboxylate, 1,4-benzenedicarboxylate, 1,3-benzenedicarboxylate, biphenyl-4,4′-dicarboxylate, benzene-1,3,5-tris(TH-tetrazole), acetylene-1,2-dicarboxylate, naphtalenedicarboxylate, adamantanetetracarboxylate, benzenetribenzoate, methanetetrabenzoate, adamantanetribenzoate, biphenyl-4,4′-dicarboxylate, imidazole, 2,5-dihydroxy-1,4-benzendicarboxylic acid, 4,4′-dihydroxy-(1,1′-biphenyl)-3,3′-dicarboxylic acid derivatives thereof, or combination(s) thereof.

In addition, the present methods can make a metal-organic framework comprising a metal ion selected from Be²⁺, Mg²⁺, Ca²⁺, Sr²⁺, Ba²⁺, Sc³⁺, Y³⁺, Ti⁴⁺, Zr⁴⁺, Hf⁴⁺, V⁴⁺, V³⁺, V²⁺, Nb³⁺, Ta³⁺, Cr³⁺, Mo³⁺, W³⁺, Mn³⁺, Mn²⁺, Re³⁺, Re²⁺, Fe³⁺, Fe²⁺, Ru³⁺, Ru²⁺, Os³⁺, Os²⁺, Co³⁺, Co²⁺, Rh²⁺, Rh⁺, Ir²⁺, Ir⁺, Pd²⁺, Pd⁺, Pt²⁺, Pt⁺, Cu²⁺, Cu⁺, Ag⁺, Au⁺, Zn²⁺, Cd²⁺, Hg²⁺, Al³⁺, Ga³⁺, In³⁺, Tl³⁺, Si⁴⁺, Si²⁺, Ge⁴⁺, Ge²⁺, Sn⁴⁺, Sn²⁺, Pb⁴⁺, Pb²⁺, As⁵⁺, As³⁺, As⁺, Sb⁵⁺, Sb³⁺, Sb⁺, and Bi⁵⁺, Bi³⁺, Bi⁺, or combination(s) thereof. In an aspect, the metal ion is Mg²⁺, Mn³⁺, Mn²⁺, Fe³⁺, Fe²⁺, Co³⁺, Co²⁺, Cu²⁺, Cu⁺, Pt²⁺, Ag⁺, Zn²⁺, Zr⁴⁺, Hf⁴⁺, or combination(s) thereof.

In an aspect, the metal-organic framework is selected from Mg-MOF-74, UiO-66 and/or HKUST-1.

As described herein, the flocculant used in the present methods includes a polymer. In an aspect, the polymer is added to the suspension in an amount between about 1 wt. % to 13 wt. % based on the solid phase. In an aspect, the polymer is p(amic acid). More specifically, the polymer solution comprises at least one polymer to induce flocculation of a suspension of metal-organic frameworks. The at least one polymer can be present in solution in an amount of 0.1% or greater (e.g., 0.1% or greater, 0.2% or greater, 0.3% or greater, 0.4% or greater, 0.5% or greater, 0.6% or greater, 0.7% or greater, 0.8% or greater, 0.9% or greater, 1.0% or greater, 1.1% or greater, 1.2% or greater, 1.3% or greater, 1.4% or greater, 1.5% or greater, 1.6% or greater, 1.7% or greater, 1.8% or greater, 1.9% or greater, 2.0% or greater, 2.1% or greater, 2.2% or greater, 2.3% or greater, 2.4% or greater, 2.5% or greater, 2.6% or greater, 2.7% or greater, 2.8% or greater, 2.9% or greater, 3.0% or greater, 3.1% or greater, 3.2% or greater, 3.3% or greater, 3.4% or greater, 3.5% or greater, 3.6% or greater, 3.7% or greater, 3.8% or greater, 3.9% or greater, 4.0% or greater, 4.1% or greater, 4.2% or greater, 4.3% or greater, 4.4% or greater, 4.5% or greater, 4.6% or greater, 4.7% or greater, 4.8% or greater, 4.9% or greater, or 5% or greater) based on total weight of a solid phase of metal-organic frameworks.

As described herein, the polymer can be present in the solvent in an amount of 5% or less (e.g., 0.1% or less, 0.2% or less, 0.3% or less, 0.4% or less, 0.5% or less, 0.6% or less, 0.7% or less, 0.8% or less, 0.9% or less, 1.0% or less, 1.1% or less, 1.2% or less, 1.3% or less, 1.4% or less, 1.5% or less, 1.6% or less, 1.7% or less, 1.8% or less, 1.9% or less, 2.0% or less, 2.1% or less, 2.2% or less, 2.3% or less, 2.4% or less, 2.5% or less, 2.6% or less, 2.7% or less, 2.8% or less, 2.9% or less, 3.0% or less, 3.1% or less, 3.1% or less, 3.3% or less, 3.4% or less, 3.5% or less, 3.6% or less, 3.7% or less, 3.8% or less, or 3.9% or less, 4.0% or less, 4.1% or less, 4.2% or less, 4.3% or less, 4.4% or less, 4.5% or less, 4.6% or less, 4.7% or less, 4.8% or less, 4.9% or less) based on total weight of the solid phase.

The polymer is an amount of from 0.5 wt. % to 15 wt. % (e.g., from 1.1% to 3.9%, from 1.2% to 3.8%, from 1.3% to 3.7%, from 1.4% to 3.6%, from 1.5% to 3.5%, from 1.6% to 3.4%, from 1.7% to 3.3%, from 1.8% to 3.2%, from 1.9% to 3.1%, or from 2% to 3%) based on total weight of the suspension. Generally, polymer is in an amount from about 0.1 wt. % to about 13.0 wt. % based on total weight of the solid phase.

The solvent used in the present methods can dissolve the reagents used in the MOF synthesis and provide a liquid suspension of resulting MOF at room temperature and pressure. Suitable examples of a solvent can include, but are not limited to, nonpolar solvents, polar aprotic solvents, polar protic solvents, water-miscible solvents, non-coordinating solvents, water, or a combination thereof. Solvent examples include, but are not limited to, acetaldehyde, acetic acid, acetone, acetonitrile, butanediol, butoxyethanol, butyric acid, diethanolamine, diethylenetriamine, dimethyl acetamide (DMAc), dimethylformamide (DMF), dimethylformamide (DEF), dimethoxy ethane, dimethyl sulfoxide (DMSO), dioxane, ethanol, ethylamine, ethylene glycol, formic acid, furfuryl alcohol, glycerol, methanol, methyl diethanolamine, N-methyl-2-pyrrolidone (“NMP”), propanol, propanediol, propanoic acid, propylene glycol, pyridine, tetrahydrofuran (“THF”), triethylene glycol, dimethyl hydrazine, hydrazine, pentane, cyclopentane, hexane, cyclohexane, benzene, toluene, chloroform, diethyl ether, dichloromethane, or a combination thereof.

Polymers, co-polymers and/or classes of polymers that are useful to induce flocculation in the present methods of making metal-organic framework include polymers and/or copolymers including polyacids, polyacrylic acids, poly(meth)acrylic acids, polysaccharides including alginic acid, xanthan gums, polyamides, polyacrylamides, polyols, polyamines, polyimides, polyamic acids, and polyesters. The polymers can contain potentially charged groups (e.g., carboxylates, ammoniums, amides, amic acids) that have different charge states dependent on the pH of the solution and/or suspension. The polymers can contain aliphatic, aromatic, ether and ester backbone groups. Heteroatoms such as chlorine or fluorine can be part of the polymer backbone as well. As described in the examples below, the polymer is added to the suspension as a polymer in solution.

Flocculation of metal-organic frameworks in a suspension allows for faster and more efficient isolation (settling of the metal-organic framework), recovery and purification (filtering and washing), increasing the space-time yields of the synthesis. The present methods use polymers to flocculate the metal-organic frameworks into aggregates which allows for more rapid production of the metal-organic frameworks. By adding one or more polymer to induce flocculation of the metal-organic frameworks results in metal-organic framework particle aggregation. The aggregates are then filtered and washed more efficiently than in the absence of the flocculant.

In the examples below, we demonstrate first that the flocculation influences efficiency and effectiveness in making metal-organic frameworks. Washing with solvent can remove unwanted excess materials from the solid phase produced. We further demonstrate that different levels of polymer can be utilized. Moreover, different polymers can be utilized in the present process including those shown below.

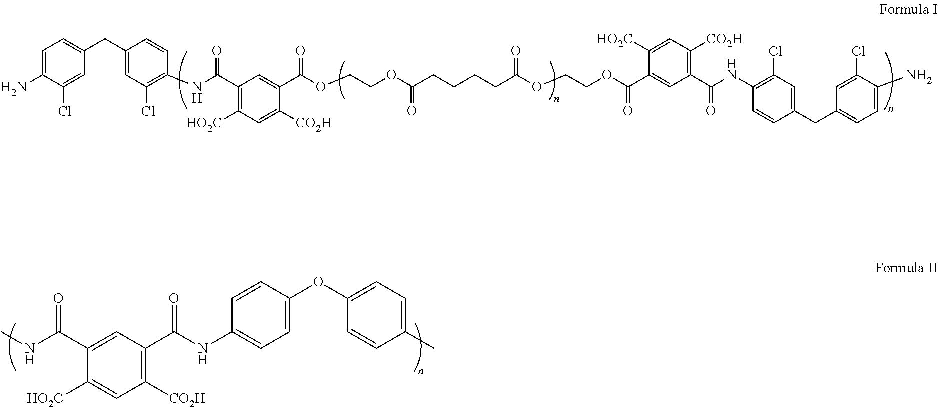

### EXAMPLES

The features of the present methods and compositions are described in the following non-limiting examples.

### Example 1: Flocculation of Mg-MOF-74

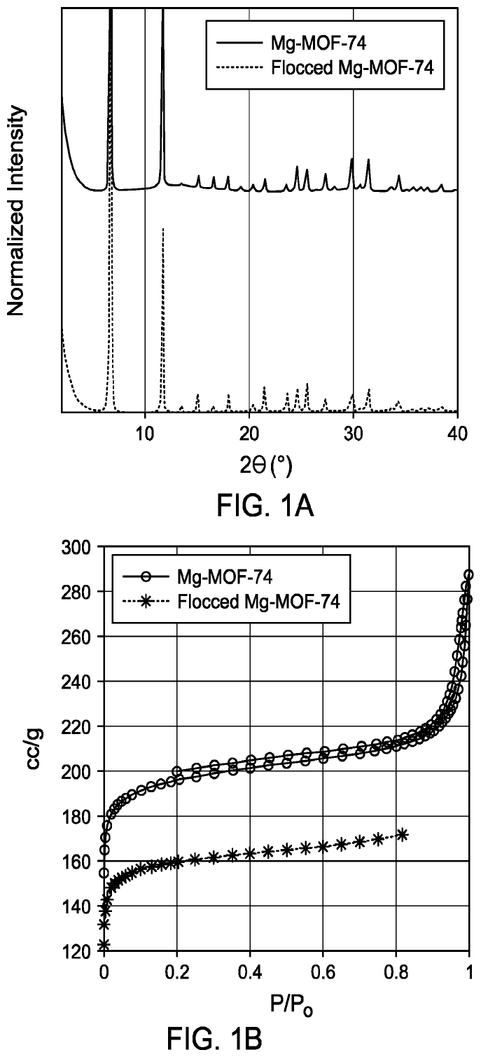

In this example, Mg-MOF-74 was successfully flocculated while surface area was retained. Two grams (2 g.) of Mg-MOF-74 powder was suspended in 18 g. N,N-dimethylformamide (DMF, 18 g) to create a MOF suspension. Varying amounts of polymer in an amic acid solution was added to the MOF suspension. In this example, the amic acid solution comprised 3.8 wt. % poly(amic acid) in DMF and resulted in a near immediate visual aggregation of the fine MOF particles. The MOF particles were allowed to settle, in which it did so faster in comparison with a comparative without poly(amic acid) addition. The MOF particles were filtered using a Buchner funnel, washed with DMF, and then copious amounts of MeOH and allowed to air-dry overnight. pXRD patterns were collected and N₂ isotherm measurements and surface area calculations were performed. The data is summarized in Table 1 and shown in FIG. TA and FIG. 1B.

TABLE 1
Making MOFs With and Without Flocculation

| | | | Surface | | Relative |
|---|---|---|---|---|---|
| | Comparative | Wt. % | Area | | Settling |
| Material | or Inventive | Polymer | (m²/g) | Crystalline | Rate |
| Mg-MOF-74 | Comparative | — | 1086 | Yes | Slow |
| Mg-MOF-74 | Inventive | 0.5 | 1059 | Yes | Fast |
| Mg-MOF-74 | Inventive | 1.0 | 1040 | Yes | Fast |
| Mg-MOF-74 | Inventive | 1.9 | 1129 | Yes | Fast |
| Mg-MOF-74 | Inventive | 3.8 | 1073 | Yes | Fast |

### Example 2: Flocculation of Mg-MOF-74

4.5 g of a 3.8 wt. % poly(amic acid) solution in DMF (Formula I) (0.171 g of polymer, 4.7 wt. % polymer solids on a theoretical amount of MOF solids) was added to a mixture of Mg-MOF-74 having a 55 to 45 ratio of N,N-dimethylformamide (DMF) to methanol (MeOH) or 80 grams of reaction mixture. MOF weight percent based on 100% yield was 4.55 wt. % by weight or 3.64 grams. This resulted in the immediate visual aggregation of the fine MOF material.

MOF was allowed to settle, in which it did so faster compared to a control without an addition of poly(amic acid), for example, having a settling rate less than two (2) minutes. The metal-organic frameworks were then filtered using a Buchner funnel, washed with DMF, then MeOH and allowed to air-dry overnight. pXRD patterns were collected and N₂ isotherm measurements and surface area calculations were performed. The data is summarized in Table 2 below.

TABLE 2
Mg-MOF-74 with and Without Flocculation and Without Washing

| | | | Surface | | Relative |
|---|---|---|---|---|---|
| | Comparative | Wt. % | Area | | Settling |
| Material | or Inventive | Polymer | (m²/g) | Crystalline | Rate |
| Mg-MOF-74 | Comparative | — | 768 | Yes | Slow |
| Mg-MOF-74 | Inventive | 4.7 | 540 | Yes, change | Fast |

### Example 3: Various Flocculants of Mg-MOF-74

In order to determine the scope of flocculation, multiple 5 gram aliquots of the reaction mixture were taken into separate vials. The reaction mixture contains Mg-MOF-74 in 55 to 45 N,N-dimethylformamide (DMF): methanol (MeOH), (80 grams of reaction mixture, MOF weight percent based on 100% yield equal to 4.55% by weight equal to 3.64 grams). To each vial (5 grams of reaction mixture, theoretical MOF based on 100% yield equal to 4.55% by weight equal to 0.23 gram), a 1 wt. % solution of the potential flocculant was added. The potential flocculating agents and results are listed in Table 3 below.

TABLE 3
Mg-MOF-74 with and Without Flocculation and Without Washing

| | | | | Relative |
|---|---|---|---|---|
| | Comparative | Wt. % | Potential | Settling |
| Material | or Inventive | Polymer | Flocculant | Rate |
| Mg-MOF-74 | Comparative | — | — | Slow |
| Mg-MOF-74 | Inventive | 4.7 | p(amic acid) | Fast |
| Mg-MOF-74 | Comparative | 4.5 | Xanthan Gum | Slow |
| Mg-MOF-74 | Comparative | 4.8 | p(N-isopropyl- | Slow |
| | | | acrylamide) | |
| Mg-MOF-74 | Comparative | 4.6 | Chitosan | Slow |
| Mg-MOF-74 | Comparative | 4.7 | p(acrylamide- | Slow |
| | | | acrylic acid/Na) | |
| Mg-MOF-74 | Comparative | 7.0 | Calcium Lactate | Slow |
| Mg-MOF-74 | Comparative | 8.1 | Calcium Chloride | Slow |
| Mg-MOF-74 | Comparative | 4.8 | Sodium Alginate | Slow |
| Mg-MOF-74 | Comparative | 4.7 | p(acrylic acid) | Slow |

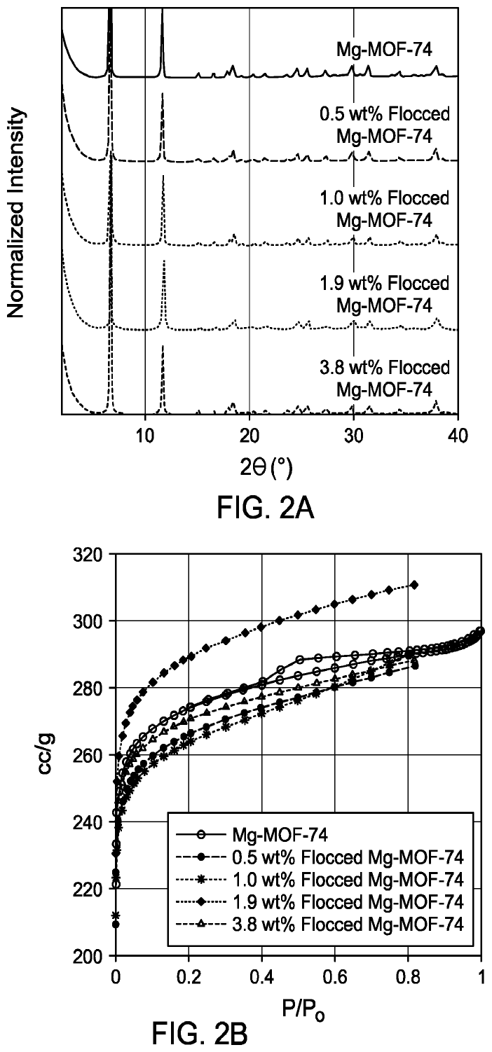

FIG. 2A shows the pXRD patterns of Mg-MOF-74 with and without flocculation using poly(amic acid) washed without copious MeOH. FIG. 2B shows the N₂ isotherms taken at 77 K.

### Example 4: Flocculation of UiO-66 with Various Polymers

UiO-66 was synthesized in a mixture of N,N-dimethylformamide (DMF) and acetic acid (“AcOH”). Following completion of the reaction, a filtration process would usually be implemented. Here, in order to demonstrate the benefit of flocculation, multiple 5 milliliter (“mL”) aliquots were taken from the reaction mixture. To the 5 mL aliquots, different polymers were added. Multiple polymers showed positive signs of flocculation. The polymers included commercially available poly(amic acid) and poly(acrylamide-co-acrylic acid) partial sodium salt. Flocculated samples were filtered using a Buchner funnel, washed with DMF, then MeOH and allowed to air-dry overnight. pXRD patterns were collected and N₂ isotherm measurements and surface area calculations were performed. The data is summarized in Table 4.

TABLE 4
UiO-66 with and Without Flocculation

| | | | | Surface | | Relative |
|---|---|---|---|---|---|---|
| | Comparative | | Wt. % | Area | Crys- | Settling |
| Material | or Inventive | Polymer | Polymer | (m²/g) | talline | Rate |
| UiO-66 | Comparative | | — | 1383 | Yes | Slow |
| UiO-66 | Inventive | p(acrylamide- | 2.5 | 1130 | Yes | Fast |
| | | acrylic | | | | |
| | | acid/Na) | | | | |
| UiO-66 | Inventive | p(amic acid) | 0.8 | 892 | Yes | Fast |
| UiO-66 | Inventive | Commercial | 12.3 | 1411 | Yes | Fast |
| | | p(amic acid) | | | | |
| UiO-66 | Inventive | p(amic acid) | 0.3 | 941 | Yes | Fast |

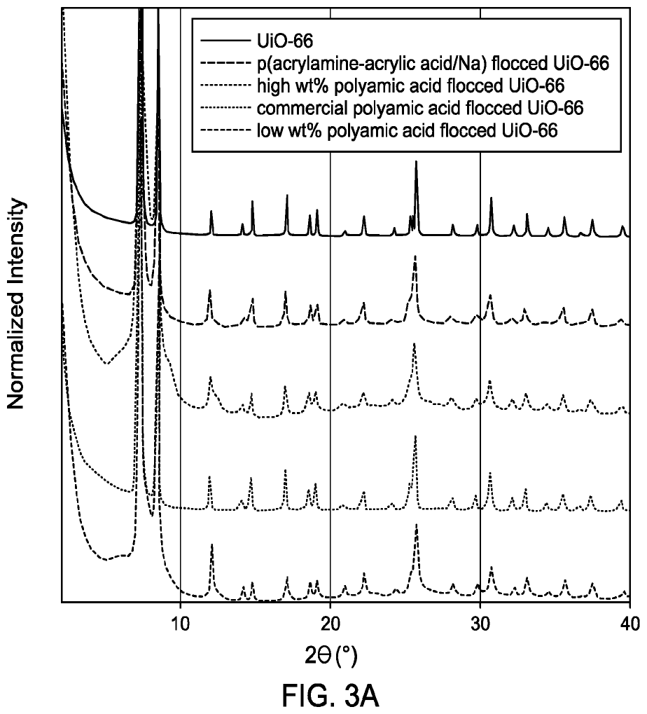

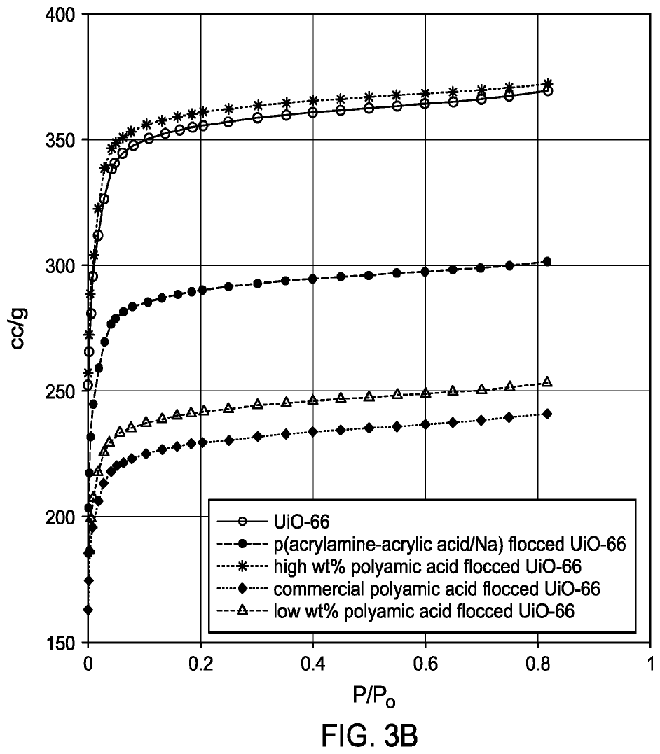

FIG. 3A shows pXRD patterns of UiO-66 with and without flocculation. FIG. 3B shows N₂ isotherms taken at 77 K.

### Example 5: Flocculation of UiO-66 with Various Polymers

HKUST-1 powder (10 grams) was suspended in a mixture of 20 grams of 50 to 50 wt. % ethanol to water. In order to determine the scope of flocculation, 5 mL aliquots were taken from the suspension and then diluted with 3 g of 50 to 50 wt. % ethanol to water and put into separate vials with the exception of the p(amic acid), where 3 extra grams were not added. To each vial (8 g of mixture, MOF equal to 20.8% by weight which was equal to 0.157 g), a 1 wt. % solution of the potential flocculant was added. Multiple polymers showed positive signs of flocculation; these polymers included poly(amic acid) (“p(amic acid)” Formula I, sodium alginate, and xanthan gum. Flocculated samples were filtered using a Buchner funnel, washed with water and then ethanol and allowed to air-dry overnight. pXRD patterns were collected and N₂ isotherm measurements and surface area calculations were performed. As can be seen, flocculation did result in some surface area loss. The data are summarized in Table 5.

TABLE 5
HKUST-1 with and Without Flocculation

| | | | | Surface | | Relative |
|---|---|---|---|---|---|---|
| | Comparative | | Wt. % | Area | Crys- | Settling |
| Material | or Inventive | Polymer | Polymer | (m²/g) | talline | Rate |
| UiO-66 | Comparative | | — | 1935 | Yes | Slow |
| UiO-66 | Inventive | p(amic acid) | 2.5 | 1538 | Yes | Fast |
| UiO-66 | Inventive | Sodium | 6.4 | 1050 | Yes | Fast |
| | | Alginate | | | | |
| UiO-66 | Inventive | Xanthan Gum | 6.5 | 1120 | Yes | Medium |

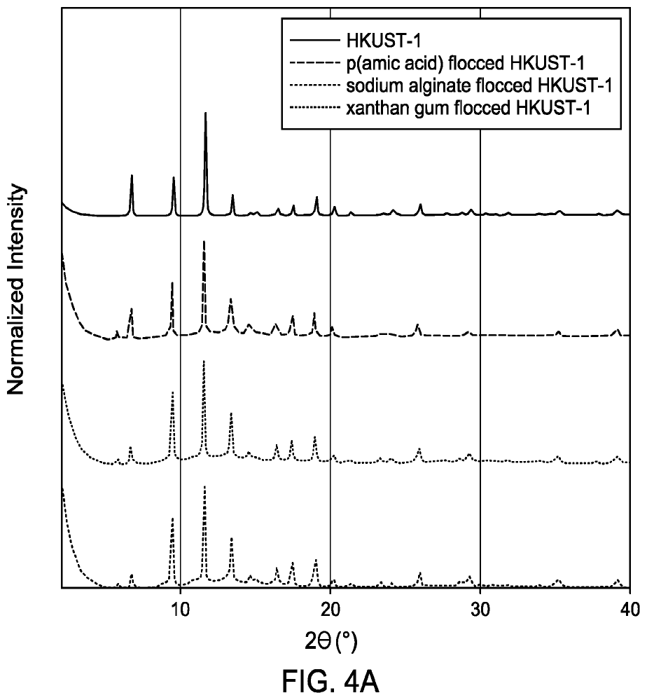

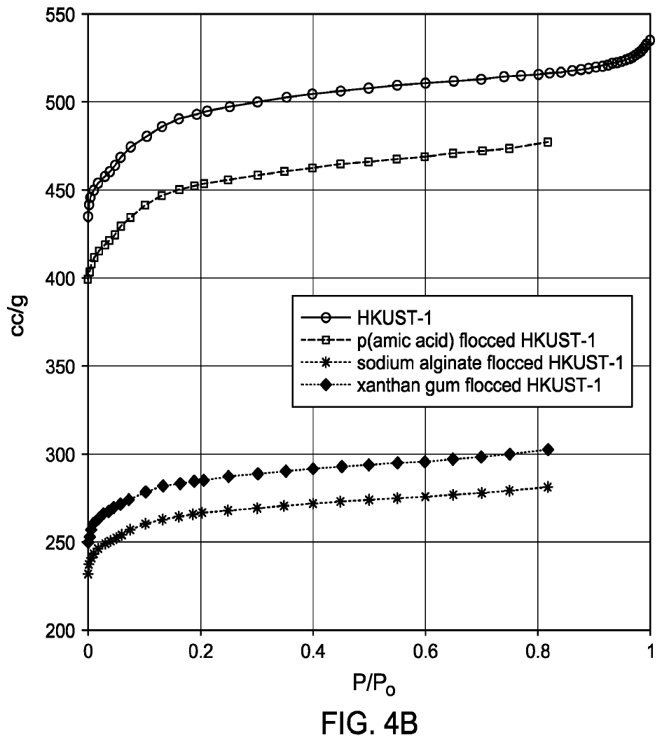

FIG. 4A shows pXRD patterns of HKUST-1 with and without flocculation. FIG. 4B shows N₂ isotherms taken at 77 K.

The polymers tested in Example 5 included the following: Xanthum gum: Xanthan gum from Xanthomonas campestris, CAS #=11138-66-2; sodium alginate: alginic acid sodium salt, CAS #=9005-38-3; poly(N-isopropylacrylamide): Mn=85,000, CAS #=25189-55-3; polyacrylamide: Mn=150,000, CAS #=9003-05-8; p(acrylamide-acrylic acid/Na): poly(acrylamide-co-acrylic acid) partial sodium salt, Mw=520,000, Mn=150,000; acrylamide ˜80 wt. %, CAS #=62649-23-4; commercial p(amic acid): poly(pyromellitic dianhydride-co-4,4′-oxydianiline), amic acid solution. see Formula II as shown above; chitosan: high molecular weight, CAS #=9012-76-4; p(amic acid), see Formula I as shown above.

When numerical lower limits and numerical upper limits are listed herein, ranges from any lower limit to any upper limit are contemplated. Although the present disclosure has been described in terms of specific aspects, it is not so limited. Suitable alterations/modifications for operation under specific conditions should be apparent to those skilled in the art. It is therefore intended that the following claims be interpreted as covering all such alterations/modifications as fall within the true spirit/scope of the disclosure.

Additionally or alternately, the invention relates to:
Embodiment 1. A method of making metal-organic frameworks comprising the steps of:
   a) forming a suspension capable of producing metal-organic frameworks;
   b) inducing flocculation of the suspension to form a plurality of flocs;
   c) allowing the flocs to separate from the suspension and produce a solid phase comprising metal-organic frameworks and a supernatant liquid phase;
   d) separating the solid phase from the supernatant liquid phase; and
   e) recovering the metal-organic frameworks from the solid phase.
Embodiment 2. The method of embodiment 1, further comprising the step of dissolving a metal salt and at least one ligand in at least one solvent to form the metal-organic framework suspension.
Embodiment 3. The method of embodiment 1 or 2, wherein flocculation is induced by the addition of a polymer solution.
Embodiment 4. The method of any one of the preceding embodiments, wherein the polymer solution comprises a poly(amic acid).
Embodiment 5. The method of any one of the preceding embodiments, wherein the polymer is added to the suspension in an amount between about 0.1 wt. % to 13 wt. % based on the solid phase.
Embodiment 6. The method of any one of the preceding embodiments, wherein the flocs are aggregates of metal-organic framework particles or crystals.
Embodiment 7. The method of any one of the preceding embodiments, wherein the flocs separate from the suspension by settling out of the suspension.
Embodiment 8. The method of any one of the preceding embodiments, wherein the solid phase is separated from the liquid phase by filtering or decanting the liquid phase from the solid phase.
Embodiment 9. The method of any one of the preceding embodiments, wherein the metal-organic frameworks are recovered from the solid phase by washing the metal-organic framework material with one or more solvents.
Embodiment 10. The method of any one of the preceding embodiments, wherein the metal-organic framework is recovered by washing the solid phase with DMF and methanol.
Embodiment 11. The method of any one of the preceding embodiments, wherein the suspension is stirred when inducing flocculation.
Embodiment 12. The method of any one of the preceding embodiments, wherein the suspension is not stirred when inducing flocculation.
Embodiment 13. A method for accelerating a rate of settling of metal-organic frameworks in a suspension comprising the steps of:
   a) providing a suspension of metal-organic frameworks;
   b) adding a flocculant to the suspension to form a plurality of flocs comprising aggregates of metal-organic framework particles; and
   c) allowing the plurality of flocs to settle out of the suspension to produce metal-organic frameworks having a surface area that is about the same as the surface area of a metal-organic framework produced under the same process conditions but without the flocculant.
Embodiment 14. The method of embodiment 13, wherein the flocculant comprises at least one soluble polymer containing amic acid groups.
Embodiment 15. A method for making metal-organic frameworks comprising the steps of:
   a) producing metal-organic frameworks in a suspension, wherein the suspension comprises a plurality of solid reagents in at least one solvent, the solid reagents comprise at least one metal salt and at least one ligand;
   b) adding a flocculant to the suspension to produce a plurality of aggregates of the metal-organic frameworks;
   c) settling the plurality of aggregates of metal-organic frameworks out of the suspension to produce a solid phase comprising the metal organic frameworks and a liquid phase; and
   d) filtering the solid phase from the liquid phase to provide the metal-organic frameworks.
Embodiment 16. The methods of embodiment 15, wherein the flocculant comprises a polymer.
Embodiment 17. The method of embodiment 16, wherein the polymer is added to the suspension in an amount between about 0.1 wt. % to 13 wt. % based on the solid phase.
Embodiment 18. The method of embodiment 16 or 17, wherein the polymer contains amic acid groups.
Embodiment 19. The method of any one of embodiments 15 to 18, wherein the solid phase is washed with DMF and methanol.
Embodiment 20. The method of any one of the preceding embodiments, wherein the metal-organic framework is selected from Mg-MOF-74, UiO-66 and/or HKUST-1.
Embodiment 21. The method of any one of the preceding embodiments, wherein the metal-organic framework comprises an organic ligand comprising one or more of:
   an alkyl group substructure having from 1 to 10 carbon atoms; or
   an aryl group substructure having from 1 to 5 aromatic rings; and
wherein the one or more substructures each have at least two X groups, and wherein X is a functional group configured to coordinate to a metal or metalloid.
Embodiment 22. The method of any one of the preceding embodiments, wherein the metal-organic framework comprises an organic ligand comprising an alkylamine substructure having from 1 to 10 carbon atoms or an arylamine or nitrogen-containing heterocycle substructure having from 1 to 5 aromatic rings; and wherein the substructure(s) each have at least two X groups, and wherein X is a functional group configured to coordinate to a metal or metalloid.
Embodiment 23. The method of embodiment 21 or 22, where each X is independently selected from neutral or ionic forms of CO₂H, OH, SH, OH₂, NH₂, CN, HCO, CS₂H, NO₂, SO₃H, Si(OH)₃, Ge(OH)₃, Sn(OH)₃, Si(SH)₄, Ge(SH)₄, Sn(SH)₃, PO₃H, AsO₃H, AsO₄H, P(SH)₃, As(SH)₃, CH(RSH)₂, C(RSH)₃, CH(RNH₂)₂, C(RNH₂)₃, CH(ROH)₂, C(ROH)₃, CH(RCN)₂, C(RCN)₃, CH(SH)₂, C(SH)₃, CH(NH₂)₂, C(NH₂)₂, CH(OH)₂, C(OH)₃, CH(CN)₂, C(CN)₃, nitrogen-containing heterocycles, sulfur-containing heterocycles, or combination(s) thereof, wherein R is an alkyl group having from 1 to 5 carbon atoms or an aryl group of 1 to 2 phenyl rings.
Embodiment 24. The method of embodiment 21 or 22, wherein the organic ligand is selected from 1,3,5-benzenetricarboxylate, 1,4-benzenedicarboxylate, 1,3-benzenedicarboxylate, biphenyl-4,4′-dicarboxylate, benzene-1,3,5-tris(1H-tetrazole), acetylene-1,2-dicarboxylate, naphtalenedicarboxylate, adamantanetetracarboxylate, benzenetribenzoate, methanetetrabenzoate, adamantanetribenzoate, biphenyl-4,4′-dicarboxylate, imidazole, 2,5-dihydroxy-1,4-benzendicarboxylic acid, 4,4′-dihydroxy-(1,1′-biphenyl)-3,3′-dicarboxylic acid derivatives thereof, or combination(s) thereof.
Embodiment 25. The method of any one of the preceding embodiments, wherein the metal-organic framework comprises a metal ion selected from Be²⁺, Mg²⁺, Ca²⁺, Sr²⁺, Ba²⁺, Sc³⁺, Y³⁺, Ti⁴⁺, Zr⁴⁺, Hf⁴⁺, V⁴⁺, V³⁺, V²⁺, Nb³⁺, Ta³⁺, Cr³⁺, Mo³⁺, W³⁺, Mn³⁺, Mn²⁺, Re³⁺, Re²⁺, Fe³⁺, Fe²⁺, Ru³⁺, Ru²⁺, Os³⁺, Os²⁺, Co³⁺, Co²⁺, Rh²⁺, Rh, Ir²⁺, Ir⁺, Pd², Pd⁺, Pt²⁺, Pt⁺, Cu²⁺, Cu⁺, Ag⁺, Au⁺, Zn²⁺, Cd²⁺, Hg²⁺, Al³⁺, Ga³⁺, In³⁺, Tl³⁺, Si⁴⁺, Si²⁺, Ge⁴⁺, Ge²⁺, Sn⁴⁺, Sn²⁺, Pb⁴⁺, Pb²⁺, As⁵⁺, As³⁺, As⁺, Sb⁵⁺, Sb³⁺, Sb⁺, and Bi⁵⁺, Bi³⁺, Bi⁺, or combination(s) thereof.
Embodiment 26. The method of embodiment 25, wherein the metal ion is selected from Mg²⁺, Mn³⁺, Mn²⁺, Fe³⁺, Fe²⁺, Co³⁺, Co²⁺, Cu²⁺, Cu⁺, Pt²⁺, Ag⁺, Zn²⁺, Zr⁴⁺, Hf⁴⁺, or combination(s) thereof.

1. A method of making metal-organic frameworks comprising the steps of:
forming a suspension capable of producing metal-organic frameworks;
inducing flocculation of the suspension to form a plurality of flocs;
allowing the flocs to separate from the suspension and produce a solid phase comprising metal-organic frameworks and a supernatant liquid phase;
separating the solid phase from the supernatant liquid phase; and
recovering the metal-organic frameworks from the solid phase.

2. The method of claim 1, further comprising the step of dissolving a metal salt and at least one ligand in at least one solvent to form the metal-organic framework suspension.

3. The method of claim 1, wherein flocculation is induced by the addition of a polymer solution.

4. The method of claim 1, wherein the polymer solution comprises a poly(amic acid).

5. The method of claim 1, wherein the polymer is added to the suspension in an amount between about 0.1 wt. % to 13 wt. % based on the solid phase.

6. The method of claim 1, wherein the flocs are aggregates of metal-organic framework particles or crystals.

7. The method of claim 1, wherein the flocs separate from the suspension by settling out of the suspension.

8. The method of claim 1, wherein the solid phase is separated from the liquid phase by filtering or decanting the liquid phase from the solid phase.

9. The method of claim 1, wherein the metal-organic frameworks are recovered from the solid phase by washing the metal-organic framework material with one or more solvents.

10. The method of claim 1, wherein the metal-organic framework is recovered by washing the solid phase with DMF and methanol.

11. The method of claim 1, wherein the suspension is stirred when inducing flocculation.

12. The method of claim 1, wherein the suspension is not stirred when inducing flocculation.

13. A method for accelerating a rate of settling of metal-organic frameworks in a suspension comprising the steps of:
providing a suspension of metal-organic frameworks;
adding a flocculant to the suspension to form a plurality of flocs comprising aggregates of metal-organic framework particles; and
allowing the plurality of flocs to settle out of the suspension to produce metal-organic frameworks having a surface area that is about the same as the surface area of a metal-organic framework produced under the same process conditions but without the flocculant.

14. The method of claim 13, wherein the flocculant comprises at least one soluble polymer containing amic acid groups.

15. A method for making metal-organic frameworks comprising the steps of:
producing metal-organic frameworks in a suspension, wherein the suspension comprises a plurality of solid reagents in at least one solvent, the solid reagents comprise at least one metal salt and at least one ligand;
adding a flocculant to the suspension to produce a plurality of aggregates of the metal-organic frameworks;
settling the plurality of aggregates of metal-organic frameworks out of the suspension to produce a solid phase comprising the metal organic frameworks and a liquid phase; and
filtering the solid phase from the liquid phase to provide the metal-organic frameworks.

16. The methods of claim 15, wherein the flocculant comprises a polymer.

17. The method of claim 16, wherein the polymer is added to the suspension in an amount between about 0.1 wt. % to 13 wt. % based on the solid phase.

18. The method of claim 16, wherein the polymer contains amic acid groups.

19. The method of any one of claim 15, wherein the solid phase is washed with DMF and methanol.

20. The method of claim 1, wherein the metal-organic framework is selected from Mg-MOF-74, UiO-66 and/or HKUST-1.

21. The method of claim 1, wherein the metal-organic framework comprises an organic ligand comprising one or more of:
an alkyl group substructure having from 1 to 10 carbon atoms; or
an aryl group substructure having from 1 to 5 aromatic rings; and
wherein the one or more substructures each have at least two X groups, and wherein X is a functional group configured to coordinate to a metal or metalloid.

22. The method of claim 1, wherein the metal-organic framework comprises an organic ligand comprising an alkylamine substructure having from 1 to 10 carbon atoms or an arylamine or nitrogen-containing heterocycle substructure having from 1 to 5 aromatic rings; and wherein the substructure(s) each have at least two X groups, and wherein X is a functional group configured to coordinate to a metal or metalloid.

23. The method of claim 21, where each X is independently selected from neutral or ionic forms of CO₂H, OH, SH, OH₂, NH₂, CN, HCO, CS₂H, NO₂, SO₃H, Si(OH)₃, Ge(OH)₃, Sn(OH)₃, Si(SH)₄, Ge(SH)₄, Sn(SH)₃, PO₃H, AsO₃H, AsO₄H, P(SH)₃, As(SH)₃, CH(RSH)₂, C(RSH)₃, CH(RNH₂)₂, C(RNH₂)₃, CH(ROH)₂, C(ROH)₃, CH(RCN)₂, C(RCN)₃, CH(SH)₂, C(SH)₃, CH(NH₂)₂, C(NH₂)₂, CH(OH)₂, C(OH)₃, CH(CN)₂, C(CN)₃, nitrogen-containing heterocycles, sulfur-containing heterocycles, or combination(s) thereof, wherein R is an alkyl group having from 1 to 5 carbon atoms or an aryl group of 1 to 2 phenyl rings.

24. The method of claim 21, wherein the organic ligand is selected from 1,3,5-benzenetricarboxylate, 1,4-benzenedicarboxylate, 1,3-benzenedicarboxylate, biphenyl-4,4′-dicarboxylate, benzene-1,3,5-tris(1H-tetrazole), acetylene-1,2-dicarboxylate, naphtalenedicarboxylate, adamantanetetracarboxylate, benzenetribenzoate, methanetetrabenzoate, adamantanetribenzoate, biphenyl-4,4′-dicarboxylate, imidazole, 2,5-dihydroxy-1,4-benzendicarboxylic acid, 4,4′-dihydroxy-(1,1′-biphenyl)-3,3′-dicarboxylic acid derivatives thereof, or combination(s) thereof.

25. The method of claim 1, wherein the metal-organic framework comprises a metal ion selected from Be²⁺, Mg²⁺, Ca²⁺, Sr²⁺, Ba²⁺, Sc³⁺, Y³⁺, Ti⁴⁺, Zr⁴⁺, Hf⁴⁺, V⁴⁺, V³⁺, V²⁺, Nb³⁺, Ta³⁺, Cr³⁺, Mo³⁺, W³⁺, Mn³⁺, Mn²⁺, Re³⁺, Re²⁺, Fe³⁺, Fe²⁺, Ru³⁺, Ru²⁺, Os³⁺, Os²⁺, Co³⁺, Co²⁺, Rh²⁺, Rh⁺, Ir²⁺, Ir⁺, Pd²⁺, Pd⁺, Pt²⁺, Pt⁺, Cu²⁺, Cu⁺, Ag⁺, Au⁺, Zn²⁺, Cd²⁺, Hg²⁺, Al³⁺, Ga³⁺, In³⁺, Tl³⁺, Si⁴⁺, Si²⁺, Ge⁴⁺, Ge²⁺, Sn⁴⁺, Sn²⁺, Pb⁴⁺, Pb²⁺, As⁵⁺, As³⁺, As⁺, Sb⁵⁺, Sb³⁺, Sb⁺, and Bi⁵⁺, Bi³⁺, Bi⁺, or combination(s) thereof.

26. The method of claim 25, wherein the metal ion is selected from Mg²⁺, Mn³⁺, Mn²⁺, Fe³⁺, Fe²⁺, Co³⁺, Co²⁺, Cu²⁺, Cu⁺, Pt²⁺, Ag⁺, Zn²⁺, Zr⁴⁺, Hf⁴⁺, or combination(s) thereof.
